(19) United States
(12) Patent Application Publication
(10) Pub. No.: US 2008/0063580 A1
(43) Pub. Date: Mar. 13, 2008

(54) Safeguard for bio-indicators in medical waste autoclaves

(76) Inventor: Wolf A. von Lersner, Longwood, FL (US)

Correspondence Address: Donald C. Simpson, 1216 Borton Landing Road, Moorestown, NJ, 08057-3055, US

(21) Appl. No.: 11/810,804

(22) Filed: Jun. 7, 2007

Related U.S. Application Data
(60) Provisional application No. 60/811,722, filed on Jun. 7, 2006.

(51) Int. Cl. B01J 3/04

(52) U.S. Cl. 422/309

(57) ABSTRACT

A bio-indicator carrier mounted on one of the rotating members in the interior of a shredding-type autoclave for use in the disintegration and sterilization of medical waste.

### CROSS-REFERENCE TO RELATED APPLICATIONS

This patent application is based on Provisional Application No. 60/811,722 filed Jun. 7, 2006, the benefit of the filing date of which is hereby claimed.

This invention relates medical waste autoclaves and to a method and apparatus capable of safeguarding bio-indicators from disintegration and/or destruction during an essentially violent autoclaving action.

### FEDERALLY SPONSORED RESEARCH

This invention was not the subject of any federally sponsored research or development.

### BACKGROUND OF THE INVENTION

The safe disposal of medical waste is rapidly growing into a crisis of major proportions as a result of the ever increasing use of throw-away materials, and a greater awareness of long-range consequences of inadequate disposal methods, combined with the lack of suitable dump sites and high tech incinerators or other methods of safe disposal. Every presently practiced disposal method for medical waste is adding increasingly to this country's medical care cost, while it is a provisorium at best and far from safe.

Autoclaving of infectious materials prior to conventional disposal renders the materials sterile and harmless so they can be disposed of with kitchen and household refuse and provides a safe, practical, and less costly method for disposing of infectious personal care waste (bandages, dressings, cotton, linen, gowns, masks, gloves, human waste, food service remnants, including plastic cups and plates, beverage cans, small instruments, needles, tubing, small glass flasks, et cetera), as well as some pathological waste such as body tissues, fluids and small bones or bone fragments. In general, these autoclaves comprise a large pressure vessel into which the waste is loaded. Steam is used to elevate the temperature inside the sealed autoclave until sterilization is achieved. The equipment used can either be configured for large municipal type use employing continuous process techniques, or it can be smaller, batch type, stand-alone processors for individual sites such as hospitals.

U.S. Pat. No. 5,217,688 describes a process and equipment which utilizes a pressures vessel fitted with either hammer mill or rotary knife tools for disintegration, together with means of heating either by injection of steam or by heat conduction through a vessel jacket. Externally the vessel is fitted with thermocouples, a condenser and associated piping, a vacuum pump, and a carbon filter. A powerful motor is used for direct drive of the disintegration members. Direct motor drives are also used for the agitator (scraper) at slow speed (20 to 120 RPM). In most such shredding-type autoclaves, a scraper/agitator is used, which rotates slowly, such as 15 to 40 revolutions per minute, inside the autoclave vessel during processing to prevent waste material from hanging up on vessel walls, folding the material back into the center of the vessel.

Medical waste processing in steam autoclaves must achieve minimum levels of sterility (microbial inactivation) to be considered safe, as outlined in United States Congress, Medical Waste Tracking Act (MWTA) of 1988, section 11008(a), (6) and (7). The use of bio-indicators as surrogate pathogen organisms to monitor the effectiveness of a medical waste autoclave sterilization process is the principal method used by industry and regulatory authorities for this purpose, and is described by Cole, Pierson, Greenwood, Leese and Foarde 1993 in the “Evaluation of Medical Waste Treatment Technologies” and “Guidance for Evaluating Medical Waste Treatment Technologies” reports for the US Environmental Protection Agency (EPA), Washington, D.C., which were supporting documents for EPA's Final Report to Congress on Medical Waste Management in the United States. In those autoclaves which include internal waste shredding or grinding simultaneously with the sterilization process, such as the processor described in U.S. Pat. No. 5,217,688 (Process for the Disposal of Medical Waste), it is almost impossible to protect bio-indicators, such as spore strips, vials, or ampules used as carriers for surrogate pathogen organisms from destruction, unless special precautions can be taken to achieve this without lessening or diminishing the effectiveness of their purpose.

### BRIEF SUMMARY OF THE INVENTION

The present invention covers a device which provides effective protection for such organism carriers from the violent action to which waste is exposed in shredding-type autoclaves. More specifically, the invention comprises a bio-indicator carrier adapted to be mounted on one of the rotating members in the interior of such shredding-type autoclaves in the small zone of reduced violent agitation that exists in the back or wake of the angled scraper blade.

### BRIEF DESCRIPTION OF THE DRAWINGS

FIG. 1 is a cutaway schematic plan view of a suitable processor or process vessel for use in the present invention such as the one shown in U.S. Pat. No. 5,217,688.

FIG. 2 is a cross-section through a-a of the apparatus of FIG. 1 in a manner to show the possible location and positioning of disintegration members such as knives within the processor.

FIG. 3A is a partially exploded perspective view of a bio-indicator safeguard device.

FIG. 3B is a cross-section through perspective view of a bio-indicator safeguard device.

FIG. 4 is essentially the same as FIG. 1 except showing a plurality of the safeguard devices mounted within the processor.

FIG. 5 is a cross-section through b-b of the wall of the apparatus of FIG. 4 showing the bio-indicator safeguard of FIG. 3 as mounted on a scraper blade.

### DETAILED DESCRIPTION OF THE INVENTION

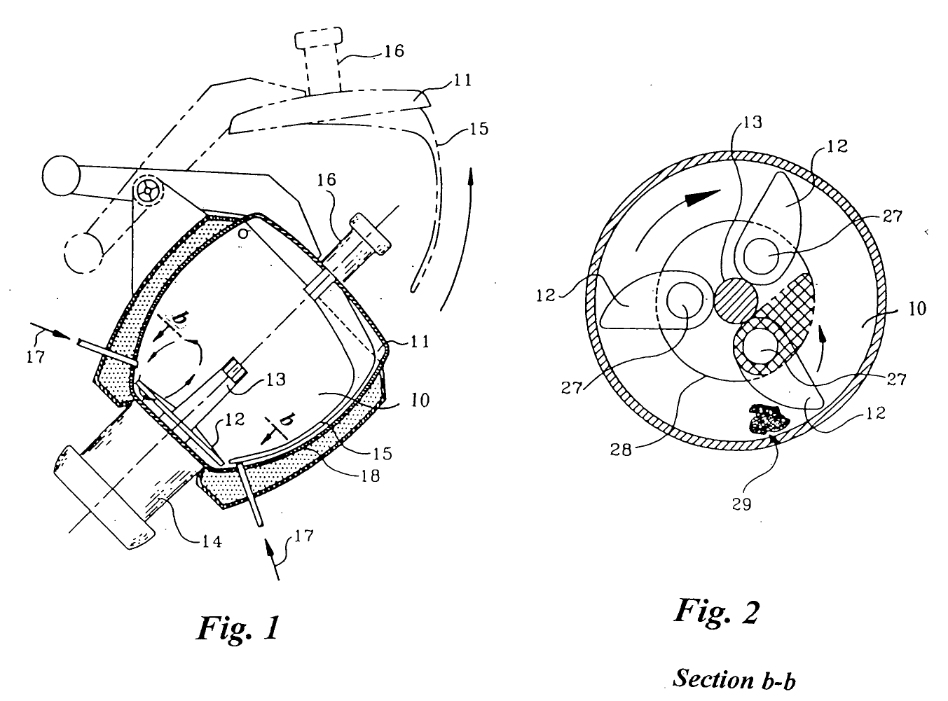

With reference to FIGS. 1 and 2, process vessel 10 is loaded with bags, packages or containers holding medical waste. The vessel is closed hermetically by lid 11 and the process is initiated. Disintegration members 12, e.g., knife blades, grinders, or impact bars mounted on shaft 13, are initially driven by motor 14 at a rate of about 900 revolutions per minute, later at 1750, and up to 3500 RPM to disintegrate the contents of the vessel. Mixer-scraper 15 assures slow circulation of all materials through the path of the cutting or disintegration members 12; it is mounted on lid 11 and driven by motor 16. Heat is supplied by tangential steam injectors or similar steam injection devices 17. Alternatively, or supplemental, heat can be supplied by introduction of heating fluid into jacket 18 to heat up the contents to about 245 to 270 degrees Fahrenheit. Steam injection is greatly preferred because it gives far greater heat transfer in a shorter period of time and reduces the likelihood of “cold” spots, i.e. locations within the materials contained in the vessel which do not reach the necessary temperature to insure sterilization of the total vessel contents. A heating jacket can be used to provide supplemental heat and further insure the reaching of the necessary temperature in the interior of the processor 10. This temperature is maintained for up to 60 minutes, depending on conditions, while size reduction continues. Since the type of waste material varies greatly, the duration of the heat application will have to be determined, e.g., by testing with inoculated material, to assure complete sterility in every case.

At the end of the sterilization process, the heat source is shut off and the interior of vessel 10 is vented to vacuum; a vacuum pump is started to draw the atmosphere from the vessel 10 through an entrained solids separator and through a heat exchanger-condenser. Because the temperature in the vessel is significantly above boiling point, the moisture, mostly water, flashes off as steam as soon as pressure is reduced, causing flash-cooling of the vessel contents. The vacuum pump draws these water vapors through the heat exchanger-condenser and exhausts entrained air through a carbon filter to eliminate odors and/or any residual organic vapors.

The lid 11 and vessel 10 must be fitted with an automatic locking device, preventing the opening of the vessel before the sterilization process has run its course. A control panel equipped with recorder, monitoring, among other things, the temperature in the process vessel 10 can “lock out” the processor 10 against opening prior to complete sterilization and provide printed copy as proof that the predetermined sterilization has been achieved.

The disintegration members are typically breaker bars or knives such as heavy-duty, curved knives 12 mounted either pivoted like mill hammers, or fixed around a center shaft for direct drive by a motor 14. These are shown in FIG. 2 as mounted on pivots 27 which in turn are mounted on knife head 28. As shown, if the knife blade hits a solid object of a type which might cause the blade to wedge or break, the blade pivots backward, thereby preserving the knife blades and eliminating the jamming of the system. The knife head and shaft continue to rotate so that the cutting edges of the various knife blades continually hit the solid object 29 until it is suitably disintegrated.

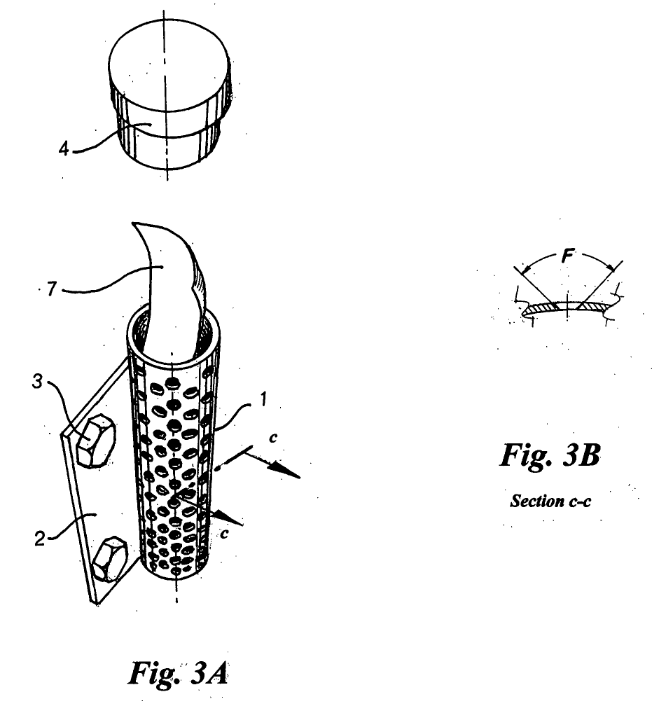

According to the present invention, as is shown in FIGS. 3-5, a suitable bio-indicator strip 37 is held in a porous retainer 31 mounted to the back of scraper blades 15. Since these scrapers are typically positioned at an angle in relation to the vessel wall 36, a small zone of reduced agitation exists in back of the scraper blade, or in its wake. One or several retaining devices, mounted to the scraper blade in this quiet zone, can effectively protect the bio-indicators without affecting their capability to react to environmental temperatures in the same manner as the remainder of the vessel content.

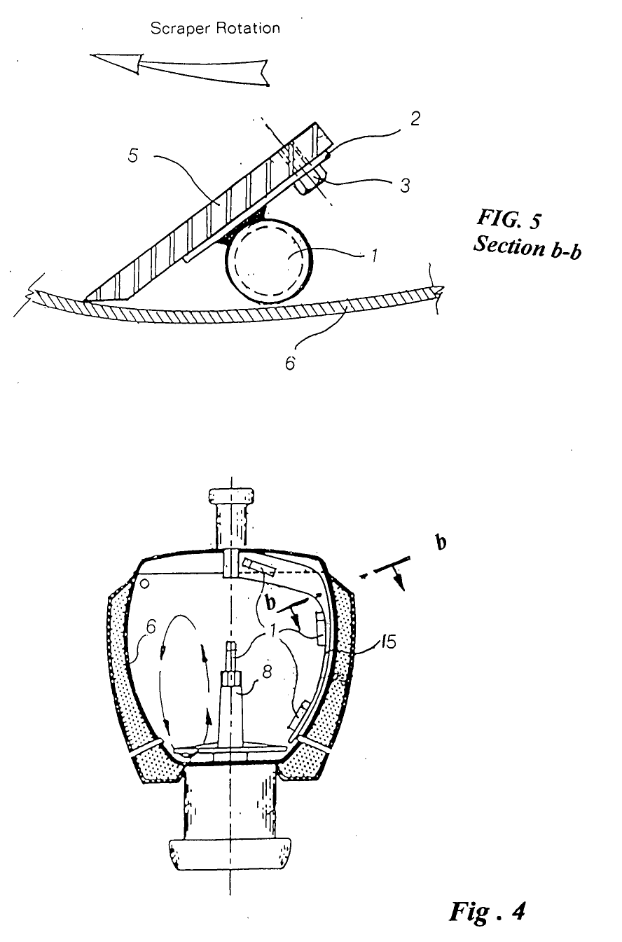

A typical retainer pursuant to this invention consists of a small metal tube 31 measuring about 3 to about 5, and preferably, about 3½ to about 4½ inches long by approximately 1¼ inch in diameter, preferably made from stainless steel, having a large number of small holes, approximately ⅛ inch (3 mm) diameter dispersed uniformly over its surface, having a solid bottom at one end, and having a removable plug or cap 34 at the other end. The retainer is fitted with a mounting plate or brackets 32 which in turn allows it to be attached easily to the scraper 15 by means of screws, bolts or clips 33. Preferably, one retainer is affixed to the scraper close to the vessel bottom, another at approximately the middle, and a third one close to the bottom of the vessel to allow for possible temperature variations from top to bottom. A fourth position can be vertically on the center of the tool shaft, i.e., coaxial with the axis of said shaft, thus positioning it in the center of the vortex, the “Eye of the Storm”, which is the very center of the vessel, as shown in FIG. 4.

Before each processing run, a bio-indicator, such as a spore strip of b. stearothermophilus, available from the Medical Products Division of the American Sterilizer Company (AMSCO) in Erie, Pa. under the trade name: Spordex Strips, measuring approximately 3 inches in length, 1 inch in width and 1/16 thickness, is placed into each retainer 31 and the retainer is securely closed by its plug or cap 34. After each run, the bio-indicators are removed from the retainers for incubation and new bio-indicators are placed into the retainers. Incubation is often done by the bio-indicator supplier or other third party laboratories and usually entails placing the spore strips into a growth media, such as Trypticase Soy Broth at 55° C. for two to seven days and to make a plate count of the number of organisms which have survived.

A preferred device in accordance with the present this invention comprises a small metal tube, as shown in No. 1 of Figure C, measuring about 4½ inches long by approximately 1¼ inch in diameter, preferably made from stainless steel, having a large number of small perforations, typically in excess of 200 with a diameter of approximately ⅛ of an inch to allow free flow of liquids and gases to contact the bio-indicator to provide prompt reaction. The holes should be countersunk from the outside at an angle of between 40 and 130°, typically about 90°, (as shown in Figure D) to prevent waste particles from lodging in the perforations and hindering or diminishing free flow and thereby encumbering the needed prompt reaction of the bio-indicators to the quickly changing environment inside the vessel. The retainers to have a solid bottom with perforations at one end, and a removable plug or cap (No. 4 in Figure C) at the other end. The retainer is fitted with a mounting plate or bracket (No. 2 in Figure C) which in turn allows it to be attached easily to the scraper (No. 5 in Figure B) by means of screws, bolts, or clips (No. 3 in Figure B). Preferably, one retainer would be affixed to the scraper close to the vessel top, another at approximately the middle, and a third one close to the bottom of the vessel to allow for possible temperature variations from top to bottom. (Figure A). A fourth position could be vertically on the center of the tool shaft (No. 8 in Figure A), thus positioning it in the very center of the vortex, the “Eye of the Storm”, which is the very center of the vessel (as shown in Figure A).

Since sterilization of the organisms in or on the bio-indicators is a function of temperature and time of exposure, the very limited process time of typically less than two minutes at maximum temperature makes it imperative that maximum exposure to the vessel environment be provided by properly designed perforations and mounting locations.

Before each processing run, a bio-indicator, such as a spore strip of b. stearothermophilus, available from the Medical Products Division of the American Sterilizer Company (AMSCO) in Erie, Pa. under the trade name: Spordex Strips, measuring approximately 3 inches in length, 1 inch in width and 1/16 thickness, is placed into each retainer. (No. 7 in Figure C). And the retainer is securely closed by its plug or screw cap. After each run, the bio-indicators are removed from the retainers for incubation and new bio-indicators are placed in the retainers. Incubation is usually done by an independent laboratory and usually entails placing spore strips into a growth media, such as Trypticase Soy broth at 55° C. for two to seven days and to make a plate count of the number of organisms which have survived.

The use of bio-indicators as surrogate pathogen organisms to monitor the effectiveness of a medical waste autoclave sterilization process is the principal method used by industry and regulatory authorities for this purpose, and is described by Cole/Pierson/Greenwood/Leese and Foarde 1993 in the “Evaluation of Medical Waste Treatment Technologies” Report for the Environmental Protection Agency (EPA), Washington, D.C. (EPA Contract No. 68-WO-0032).

While the practice of the invention has been illustrated with the use of spore strips, it is not so limited. Any form of bio-indicator may be utilized provided it is of a size and shape to fit into and be protected by the retainer of the present invention. For example, tubes of liquid bio-indicator can be employed, e.g., the Chemspore ampules available from the Medical Products Division of the American Sterilizer Company (AMSCO) are equally useful herein. The bio-indicator can also be in rod form provided the rods will fit into and be contained by the invention retainer. Similarly, modifications of the retainer itself are possible within the spirit of the present invention. It need not be made of metal but can be made of any material having the necessary thermal and impact properties to withstand the conditions encountered by the scraper blade during operation within the autoclave, e.g., high density polyethylene or polypropylene. Other variations will be apparent to those persons of ordinary skill in the art in the course of using the present invention.

What I claim as my invention is:

1. In a disintegrating autoclave for the simultaneous disintegration and sterilization of potentially infectious waste products comprising a substantial amount of discrete solid materials, said disintegrating autoclave comprising a steam heated pressure vessel equipped with at least two internal moving tools comprising (a) a motor-driven shaft having disintegrators mounted thereon adapted to impact waste products confined in said vessel upon rotation of said shaft and (b) a motor-driven mixer-scraper blade adapted to stir the contents of said vessel and simultaneously scrape the inner wall of said vessel, the improvement which comprises at least one porous tubular bio-indicator retaining means mounted on at least one of said internal moving tools and adapted to contain and retain a bio-indicator while said internal moving tool contacts waste material confined in said disintegrating autoclave and to permit removal of said bio-indicator at the end of any autoclaving cycle.

2. The improved disintegrating autoclave of claim 1 in which said porous tubular bio-indicator retaining means is mounted to said motor-driven mixer-scraper blade (b).

3. The improved disintegrating autoclave of claim 1 in which a plurality of said porous tubular bio-indicator retaining means are mounted to said motor-driven mixer-scraper blade (b).

4. The improved disintegrating autoclave of claim 1 in which said porous tubular bio-indicator retaining means is mounted on said motor-driven shaft (a) coaxially therewith.

5. The improved disintegrating autoclave of claim 1 in which a porous tubular bio-indicator retaining means is mounted on said motor-driven shaft (a) coaxially therewith and at least one porous tubular bio-indicator retaining means is mounted to said motor-driven mixer-scraper blade (b).
